(19) United States
(12) Patent Application Publication
(10) Pub. No.: US 2009/0249058 A1
(43) Pub. Date: Oct. 1, 2009

(54) SYSTEM AIDING FOR DESIGN

(75) Inventors: Junko TAIRA, Kawasaki (JP); Miki Takagi, Kawasaki (JP); Yoshitomo Kumagai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/411,640

(22) Filed: Mar. 26, 2009

(30) Foreign Application Priority Data
Mar. 28, 2008 (JP) 2008-086128

(51) Int. Cl. G06F 1/24

(52) U.S. Cl. 713/100

(57) ABSTRACT

A system aiding for design includes a determining unit determining whether it is possible to first product data with second product data by comparing interface data of the first product data with interface data of the second product data and a replacing unit replacing the first product data contained in design data with the second product data when the determining unit determines that replacement is possible.

### CROSS-REFERENCE TO APPLICATION

This application is based upon and claims the benefit of priority to Japanese Patent Application No. 2008-86128, filed on Mar. 28, 2008, the entire contents of which are incorporated herein by reference.

### BACKGROUND

1. Field

An aspect of the invention relates to a system aiding for design.

2. Description of the Related Art

In designing an information technology (IT) infrastructure system (e.g., a network system), a designer (e.g., a system engineer) sometimes wishes to utilize an existing drawing used in an intermediate stage of designing or in the completion of designing. In such a case, an initially installed component (e.g., a central processing unit (CPU), a hard disk drive (HDD), or a memory) in a product (e.g., a server, a hub, or a storage) used in a system may have been altered, or the number of add-on devices (e.g., memory slots) may have been changed.

Typically, such utilization of an existing design in an IT infrastructure system is manually made by a designer. One example of a technique for managing a network system being one example of the IT infrastructure system is a network management system that detects a device newly connected to the network, downloads a management function for managing the detected device, and installs it (see, for example, Japanese Laid-open Patent Publication No. 2003-8575).

In manually utilizing an existing design in a system, an error commonly occurs when the designer updates an earlier-version product contained in earlier-version design data to the latest-version product.

Here, one approach to the case in which components in the earlier-version product are altered in the latest-version product is a technique for replacing the earlier-version product with the latest-version product at once. In this case, however, when the earlier-version product is replaced with the latest-version one at once without a determination of whether the earlier-version product can be replaced with the latest-version one, if the number of add-on devices connected to the latest-version product is smaller than that in the earlier-version one, a problem arises in which the latest-version product is lacking in an add-on device that stores an add-on component (e.g., a memory) stored in an add-on device in the earlier-version product.

For example, a case in which one existing system is utilized in a new design is described below. FIG. 24 is an illustration used for describing a problem discussed herein. FIG. 24A illustrates an example screen on which earlier-version design data that contains an earlier-version product A included in the system is displayed. FIG. 24B illustrates a problem arising when the earlier-version product A is replaced with the latest-version product A without a determination of whether the earlier-version product A can be replaced with the latest-version product A. As illustrated in FIG. 24A, a part p1 of the earlier-version product A at the time of designing that product A has two memory slots 200 for add-ons. That is, the product A is designed by a designer so as to have two 2G memories mounted thereon. When the latest-version product A being on the market at the time of utilizing an existing design has only one memory slot 200 for an add-on in the part p1, if the earlier-version product A is replaced by the latest-version product A, the earlier-version product A is lacking in a slot for receiving a memory (memory slot 200 for an add-on), as illustrated in FIG. 24B. This is because information on the memories mounted on the earlier-version product A remains in design data of the latest-version product A replacing the earlier-version product A even after the replacement. The solid black portion in FIG. 24B indicates a memory inserted in a memory slot for an add-on that does not actually exist in the latest-version product A.

As described above with reference to FIGS. 24A and 24B, when the earlier-version product A is replaced with the latest-version product A without a determination of whether the earlier-version product A can be replaced with the latest-version product A, a problem arises in which the latest-version product A is lacking a slot for receiving a memory.

### SUMMARY

A system aiding for design includes a determining unit determining whether it is possible to replace first product data with second product data by comparing interface data of the first product data with interface data of the second product data and a replacing unit replacing the first product data contained in design data with the second product data when the determining unit determines that replacement is possible.

An aiding method for design including determining whether it is possible to replace first product data with second product data by comparing interface data of the first product data with interface data of the second product data and replacing the first product data contained in design data with the second product data when the determining unit determines that replacement is possible.

A computer-readable recording medium encoded with a computer program that causes a computer to operate as a system aiding for design, the program when executed by a computer causes the computer to perform a method including determining whether it is possible to replace first product data with second product data by comparing interface data of the first product data with interface data of the second product data and replacing the first product data contained in design data with the second product data when the determining unit determines that replacement is possible.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 illustrates an example configuration of a system aiding for design according to an embodiment of the present invention;

FIG. 2 illustrates an example structure of design data;

FIG. 3 illustrates an example structure of library information;

FIG. 4 illustrates an example flowchart of a process in an aiding method for design according to a first embodiment of the present invention;

FIG. 5 illustrates an example of design data;

FIG. 6 illustrates an example of a product library;

FIG. 7 illustrates an example of design data;

FIG. 8 illustrates an example of a product library;

FIG. 9A and FIG. 9B illustrates how a comment of information of a product library is displayed;

FIG. 10 illustrates an example of design data;

FIG. 11 illustrates an example of a product library;

FIG. 12 illustrates an example of design data;

FIG. 13 illustrates an example of an error list;

FIG. 14 illustrates an example flowchart of a process in an aiding method for design according to a second embodiment;

FIG. 15 illustrates an example of design data;

FIG. 16 illustrates an example of a product library;

FIG. 17 illustrates an example of design data;

FIG. 18 illustrates an example of a product library;

FIG. 19 illustrates an example of design data;

FIG. 20 illustrates an example of a product library;

FIG. 21 illustrates an example of design data;

FIG. 22 illustrates an example of an error list;

FIG. 23A and FIG. 23B illustrates an example configuration of a network system; and

FIG. 24A and FIG. 24B illustrates an example of a problem.

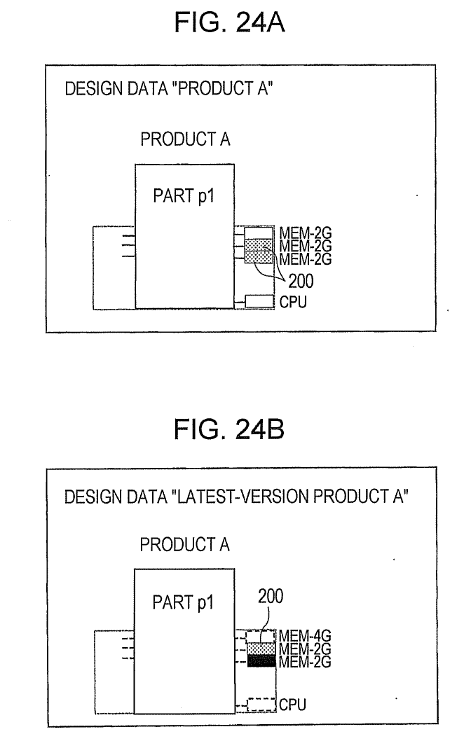

### DESCRIPTION OF THE PREFERRED EMBODIMENTS

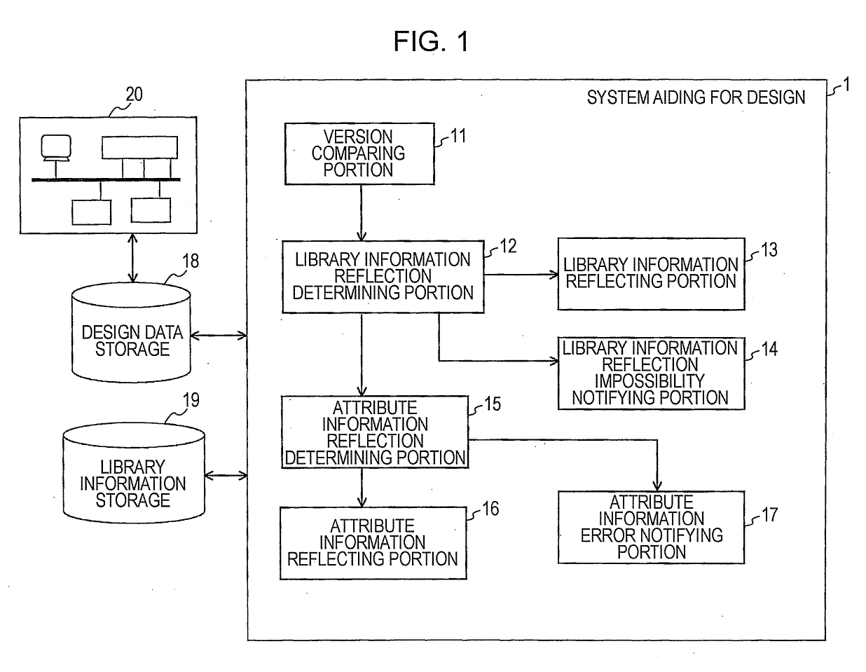

Embodiments of the present invention are described below with reference to the drawings. FIG. 1 illustrates an example configuration of a system aiding for design according to an embodiment. A system aiding for design 1 is a processing device that determines whether first product data contained in design data can be replaced with second product data and replaces the first product data contained in the design data with the second product data in accordance with the determination. The first and second product data can be, for example, a product library described later. The determination may be made when the data is read or when the design data is edited.

The system aiding for design 1 includes a version comparing portion 11, a library information reflection determining portion 12, a library information reflecting portion 13, a library information reflection impossibility notifying portion 14, an attribute information reflection determining portion 15, an attribute information reflecting portion 16, and an attribute information error notifying portion 17. First, functions of each processing portion are described in the case where the system aiding for design 1 has a configuration of determining whether first product data contained in design data for an IT infrastructure system can be replaced with second product data when the system aiding for design 1 starts operating and reads the design data.

The version comparing portion 11 compares a version of a product (or part) in design data in the design data storage 18 with a version of a product (or part) in the latest library information in the library information storage 19 for each of the products included in the IT infrastructure system. Additionally, the version comparing portion 11 determines whether there is a necessity to replace the product (part) in the design data with the latest-version product (part) in accordance with the comparison. The library information contains a product library, a part library, a macro circuit, and an index file, which are described later.

The library information reflection determining portion 12 compares a physical condition of the product in the design data with a physical condition of the product in the latest library information. Additionally, the library information reflection determining portion 12 determines whether the design data is to reflect the latest library information (whether an earlier-version product library captured in the design data can be replaced with a latest-version product library contained in the latest library information) in accordance with the comparison.

When there is no contradiction between the physical condition of the product in the design data and that in the latest library information, the library information reflection determining portion 12 determines that the design data is to reflect the latest library information. When there is a contradiction between the physical condition of the product in the design data and that in the latest library information, the library information reflection determining portion 12 determines that the design data is to reflect the library information.

The library information reflecting portion 13 replaces the earlier-version product library contained in the design data with the latest product library contained in the latest library information. When the library information reflection determining portion 12 determines that the design data is not to reflect the latest product information, the library information reflection impossibility notifying portion 14 provides a notification of the determination. When the library information reflecting portion 13 replaces the earlier-version product library contained in the design data with the latest product library, the attribute information reflection determining portion 15 determines whether new design data containing the latest product library replacing the earlier-version product library can reflect (inherit) attribute information that is specified (by an input from a designer) in design data prior to reflection in the latest library information and that is indicated by the earlier-version product library.

When the attribute information reflection determining portion 15 determines that the new design data can inherit the attribute information specified in the design data prior to the reflection in the latest library information, the attribute information reflecting portion 16 makes the new design data reflect the attribute information.

When the attribute information reflection determining portion 15 determines that the inheritance is impossible, the attribute information error notifying portion 17 provides a notification of an error occurring in reflecting the attribute information. The design data storage 18 stores the design data. The design data is data corresponding to a system configuration diagram 20 and contains a product library, a part library, a macro circuit, and attribute information specified by an input from a designer, which are described later. The library information storage 19 stores the library information.

Functions of each processing portion are described next in the case in which the system aiding for design 1 has a configuration of determining whether first product data contained in design data can be replaced with second product data in editing the design data in response to an input from a designer (in replacing each of the products included in the IT infrastructure system).

The library information reflection determining portion 12 compares a physical condition of a product to be replaced (pre-replacement product) in library information of the pre-replacement product contained in the design data with a physical condition of a product (post-replacement product) to replace the pre-replacement product in library information of the post-replacement product and determines whether the replacement of the product is possible. For example, when the designer inputs an instruction to replace a product A with a product B, the library information reflection determining portion 12 compares attribute information (e.g., the number of interfaces, positional information of each interface) on parts included in the product A specified in a product library corresponding to the product A with attribute information on parts included in the product B specified in a product library corresponding to the product B. The library information reflection determining portion 12 determines whether the product A can be replaced with the product B (whether the product library of the product A can be replaced with the product library of the product B) in accordance with the comparison.

When the library information reflection determining portion 12 determines that the replacement of the product is possible, the library information reflecting portion 13 makes the design data for the IT infrastructure system reflect the library information of the post-replacement product (e.g., the product library corresponding to the product B).

When the library information reflection determining portion 12 determines that the replacement of the product is impossible, the library information reflection impossibility notifying portion 14 provides an error notification.

The attribute information reflection determining portion 15 compares the attribute information of the product specified (by an input from the designer) in the design data prior to the replacement of the product with the attribute information of the product contained in the library information corresponding to the post-replacement product. Then, the attribute information reflection determining portion 15 determines whether the design data after the replacement of the product can reflect (inherit) the attribute information specified in the design data before the replacement of the product in accordance with the comparison.

When the attribute information reflection determining portion 15 determines that the design data after the replacement of the product can inherit the attribute information of the product specified in the design data before the replacement of the product, the attribute information reflecting portion 16 makes the design data after the replacement of the product reflect the attribute information specified in the design data before the replacement of the product.

When the attribute information reflection determining portion 15 determines that the design data after the replacement of the product cannot inherit the attribute information of the product specified in the design data before the replacement of the product, the attribute information error notifying portion 17 provides an error notification.

The system aiding for design 1 and the functions of each of the processing portions included in the system aiding for design 1 are carried out by a central processing unit (CPU) and a program running thereon. The program carrying out the system aiding for design 1 can be stored in a computer-readable storage medium, such as a semiconductor memory, a hard disc, a compact-disc read-only memory (CD-ROM), and a digital versatile disc (DVD). The program can be provided through such a storage medium that stores the program or through transmission and reception using a network over a communication interface.

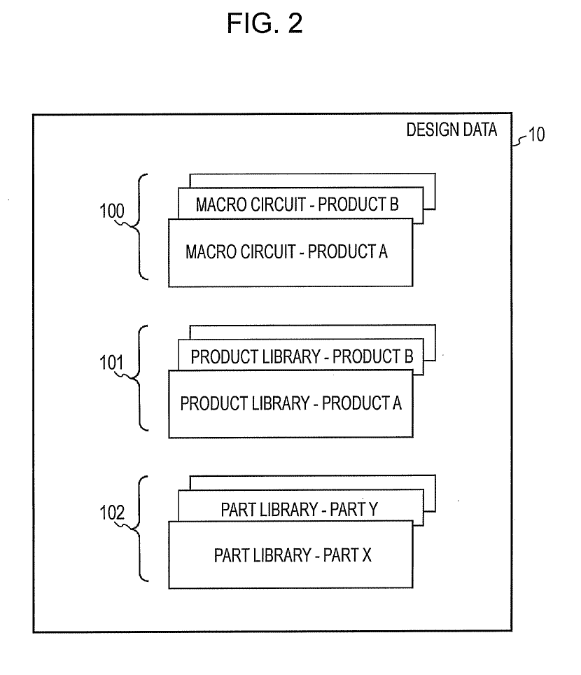

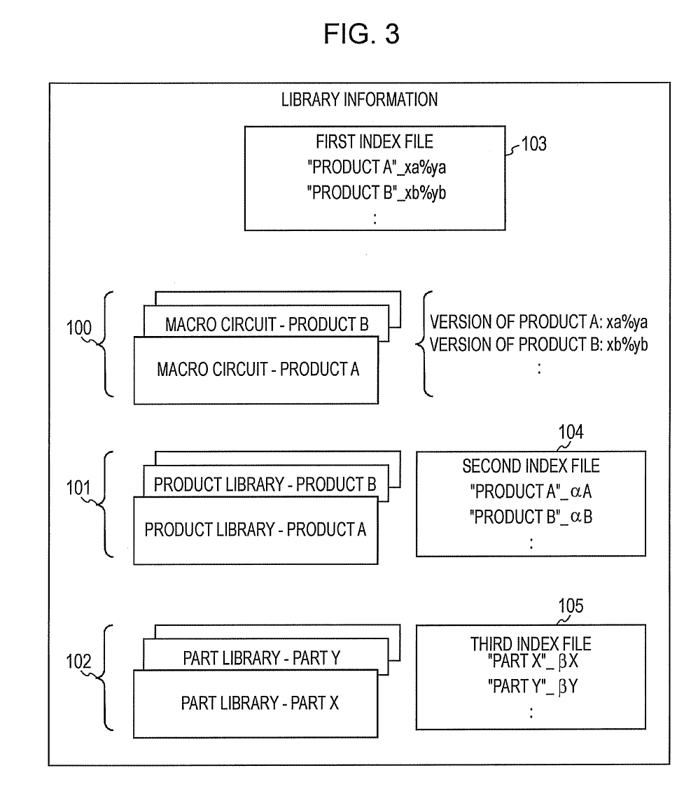

FIG. 2 illustrates an example structure of design data. Design data 10 has captured library information (information containing a macro circuit 100, a product library 101, and a part library 102), which is described later with reference to FIG. 3. The design data contains attribute information specified by an input from a designer (e.g., information on settings of an operating system (OS) for the product).

FIG. 3 illustrates an example structure of library information. The library information contains the macro circuit 100 for each product, the product library 101 for each product, the part library 102 for each part, a first index file 103, a second index file 104, and a third index file 105. The macro circuit 100 is information about the structure of a device (product, part). The macro circuit 100 contains information on a version (major version and minor version) of the product. The product library 101 contains a version of the product, attribute information of the product, information of a list of parts of the product, and attribute information of each part. For a product, the macro circuit 100 and the product library 101 are in a one-to-one correspondence.

The part library 102 contains a version of the part and attribute information on the part. The first index file 103 is an index file generated in advance on the basis of the macro circuit 100 and contains information on the version of each product contained in the macro circuit 100. For example, information “product A”_xa % ya in the first index file 103 illustrated in FIG. 3 indicates that the major version of the product A is xa and the minor version thereof is ya.

The second index file 104 is an index file generated in advance on the basis of the product library 101 and contains information on the version of the product contained in the product library 101. For example, information “product A”_□A in the second index file 104 illustrated in FIG. 3 indicates that the version of the product A is □A.

The third index file 105 is an index file generated in advance on the basis of the part library 102 and contains information on the version of the part contained in the part library 102. For example, information “part X”_□X in the third index file 105 illustrated in FIG. 3 indicates that the version of the part X is □X.

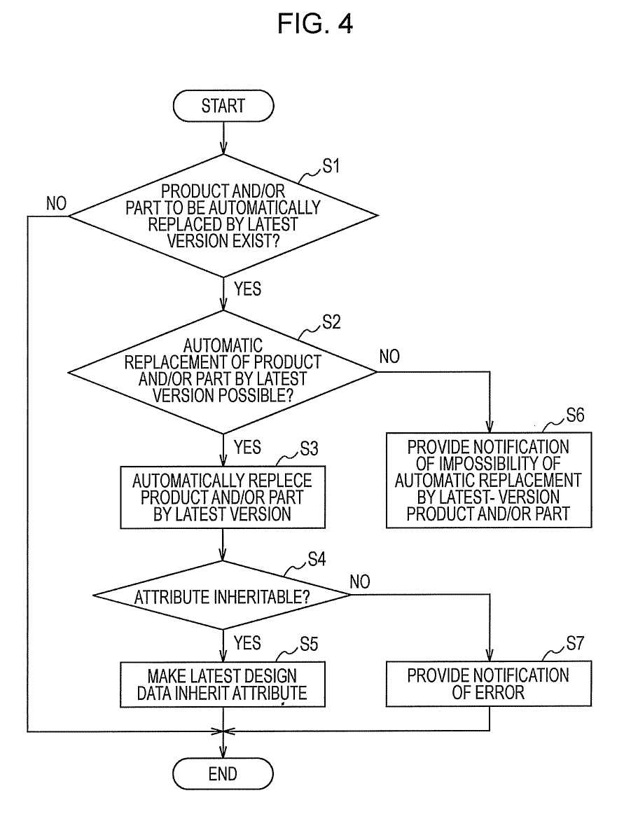

A first embodiment of the present invention is described below. FIG. 4 illustrates an example flowchart of a process in an aiding method for design according to the first embodiment of the present invention. First, in step S1, the version comparing portion 11 determines whether there is a product and/or a part to be replaced with the latest-version one(s) among products and parts in design data. Specifically, the version comparing portion 11 acquires the design data 10 from the design data storage 18 and acquires the latest library information from the library information storage 19. Then, the version comparing portion 11 compares information on the version of the product and/or part contained in the design data 10 with information on the version of the product and/or part contained in the index file in the latest library information. The version comparing portion 11 determines whether there is a need to replace the product and/or part with the latest-version one(s) in accordance with the comparison.

For example, the version comparing portion 11 can compare the version of the product contained in the macro circuit captured in the design data 10 with the version of that product contained in the first index file 103 in the latest library information. The version comparing portion 11 determines whether there is a need to replace that product with the latest-version one in accordance with the comparison. When the major version of the product contained in the macro circuit captured in the design data 10 differs from the major version of that product contained in the first index file 103, the version comparing portion 11 determines that it is unnecessary to convert that product into the latest-version one. When the major version of the product contained in the macro circuit captured in the design data 10 is the same as the major version of that product contained in the first index file 103 and when the minor version of that product contained in the first index file 103 is larger than the minor version of that product contained in the macro circuit, the version comparing portion 11 determines that there is a need to convert that product into the latest-version one.

The version comparing portion 11 compares the version of a product contained in a product library captured in the design data 10 with the version of that product contained in the second index file 104 in the latest library information and determines whether there is a need to replace that product with the latest-version one in accordance with the comparison. The version comparing portion 11 compares the version of a part contained in a part library captured in the design data 10 with the version of that part contained in the third index file 105 in the latest library information and determines whether there is a need to replace that part with the latest-version one in accordance with the comparison.

When the version comparing portion 11 determines that it is unnecessary to replace the product and/or part with the latest-version one(s), the process is completed. When the version comparing portion 11 determines that there is a need to replace the product and/or part with the latest-version one(s), the flow proceeds to step S2.

In step S1, for example, it is assumed that the version of the product A contained in the macro circuit captured in the design data 10 is 02%04 and the version of the product A contained in the first index file 103 in the latest library information is 03%01. In this case, the major version “03” of the product A contained in the first index file 103 is larger than the major version “02” of the product A contained in the macro circuit captured in the design data 10. Accordingly, the version comparing portion 11 determines that it is unnecessary to replace the product A with the latest-version one.

Alternatively, for example, it is assumed that the version of the product A contained in the macro circuit captured in the design data 10 is 02%04 and the version of the product A contained in the first index file 103 in the latest library information is 02%05. In this case, the version “02” of the product A contained in the first index file 103 in the latest library information is the same as the major version “02” of the product A contained in the macro circuit captured in the design data 10, and the minor version “05” of the product A contained in the first index file 103 is larger than the minor version “04” of the product A contained in the macro circuit captured in the design data 10. Accordingly, the version comparing portion 11 determines that there is a need to replace the product A with the latest-version one.

In step S2, the library information reflection determining portion 12 determines whether it is possible to replace the product and/or part with the latest-version one(s). Specifically, the library information reflection determining portion 12 compares a physical condition of the product and/or part in the library information captured in the design data 10 with a physical condition of the product and/or part in the latest library information. When there is no contradiction between the physical condition of the product and/or part in the library information captured in the design data 10 and the physical condition of the product and/or part in the latest library information, the library information reflection determining portion 12 determines that the product and/or part can be replaced with the latest-version one(s) (that the design data is to reflect the latest library information), and the flow proceeds to step S3. When there is a contradiction therebetween, the library information reflection determining portion 12 determines that the product and/or part associated with the library information captured in the design data 10 is not to be replaced with the latest-version one(s) (that the design data 10 is not to reflect the latest library information), the flow proceeds to step S6.

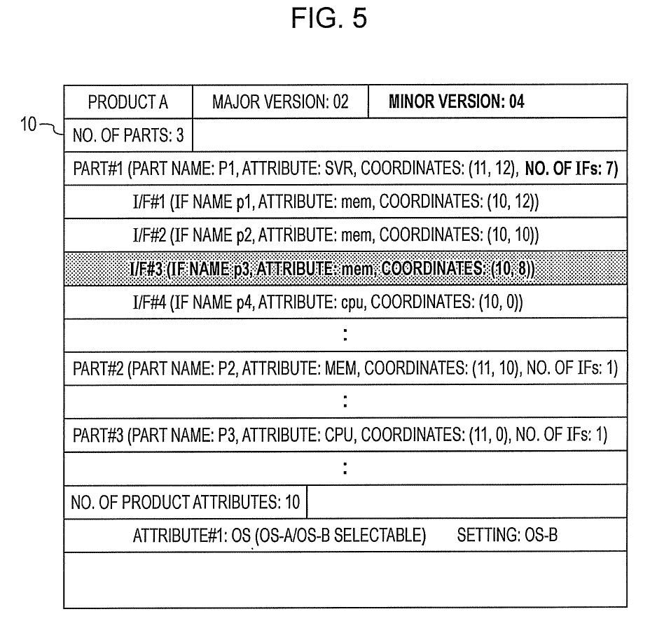

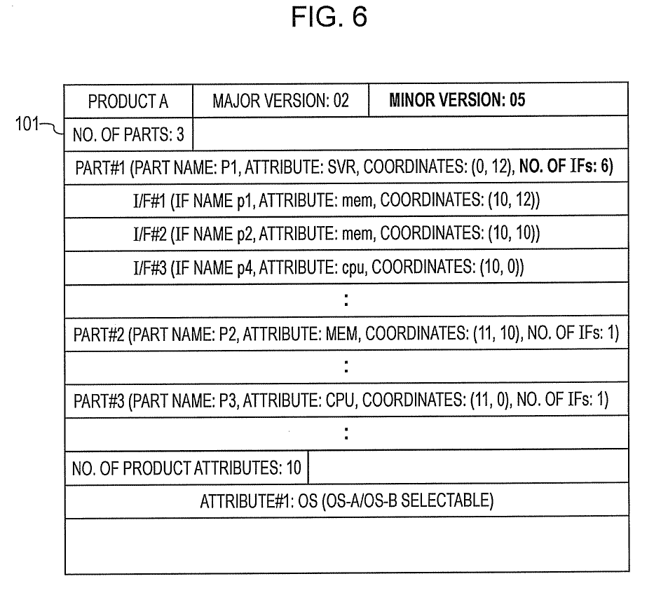

FIG. 5 illustrates an example of an earlier version of the design data 10 capturing an earlier-version product library of the product A. FIG. 6 illustrates an example of the product library 101 of the product A in the latest library information. The information in the design data 10 illustrated in FIG. 5 is information in the product library of the earlier-version product A captured in the design data 10. Each of the design data 10 illustrated in FIG. 5 and the product library 101 illustrated in FIG. 6 contains the number of parts of the product A, a list of the parts of the product A (parts #1 to #3), attributes of the product A (attribute #1, . . . ), attribute information on a part (in the example illustrated in FIG. 5, part name, attribute, coordinates, and the number of interfaces (IFs)), and information on an IF of the part (in the example illustrated in FIG. 5, IF name, attribute, and coordinates). For example, the attribute mem specified for an IF indicates that the IF is associated with a memory and the attribute cpu specified for an IF indicates that the IF is associated with a CPU. The coordinates specified for an IF indicate the position of the IF. In the example illustrated in FIG. 5, the attribute #1 is information about software operating in the product A specified by an input from a designer. The attribute #1 indicates that “OS-B” is set as the operating system associated with the product A. The attribute #1 specified in the product library 101 illustrated in FIG. 6 indicates that OS-A and OS-B are selectable as the operating system associated with the product A.

For example, the library information reflection determining portion 12 can determine whether there is a contradiction between the number of interfaces, the attribute of each interface, and the coordinates thereof in the design data 10 illustrated in FIG. 5 and those in the product library 101 illustrated in FIG. 6. Referring to FIGS. 5 and 6, the number of interfaces of the part #1 in the design data 10 illustrated in FIG. 5 is seven, whereas the number of interfaces of the part #1 in the product library 101 illustrated in FIG. 6 is six. The attribute and coordinates of the IF #3 of the part #1 in the design data 10 illustrated in FIG. 5 are not present in the product library 101 illustrated in FIG. 6. That is, information of the hatched portion in FIG. 5 contradicts information included in the product library 101 illustrated in FIG. 6. Therefore, the library information reflection determining portion 12 determines that the product A indicated by the design data 10 illustrated in FIG. 5 cannot be replaced with the latest-version product (product A indicated by the product library 101 illustrated in FIG. 6).

In step S2, in a similar manner to the above description with reference to FIGS. 5 and 6, the library information reflection determining portion 12 may compare an earlier-version product library captured in earlier-version design data with the latest product library and may determine whether an add-on device (e.g., memory slot) connected to a product indicated by the earlier-version product library can be connected to a product indicated by the latest product library. When determining that the add-on device connected to the product indicated by the earlier-version product library can be connected to the product indicated by the latest product library, the library information reflection determining portion 12 determines that the product indicated by the earlier-version product library can be replaced with the product indicated by the latest product library.

Alternatively, the library information reflection determining portion 12 may determine whether all add-on devices of a product indicated by the earlier-version product library can be connected to the product indicated by the latest product library and may determine whether the product indicated by the earlier-version product library can be replaced with the product indicated by the latest product library in accordance with the determination. For example, when two memory slots for add-ons are connected to the product A in the earlier-version design data capturing the earlier-version product library and only one memory slot for an add-on is connected to the product A in the latest product library, the library information reflection determining portion 12 determines that the product A cannot be replaced with the latest-version product A.

Alternatively, the library information reflection determining portion 12 may determine whether, for example, all communication cables connected to a product indicated by an earlier-version product library can be connected to a product indicated by the latest product library and may determine whether the product indicated by the earlier-version product library can be replaced with the product indicated by the latest product library in accordance with the determination.

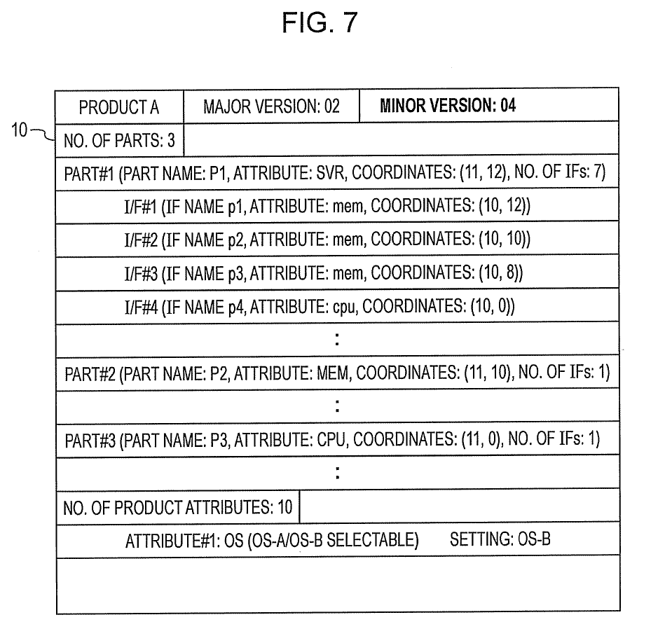

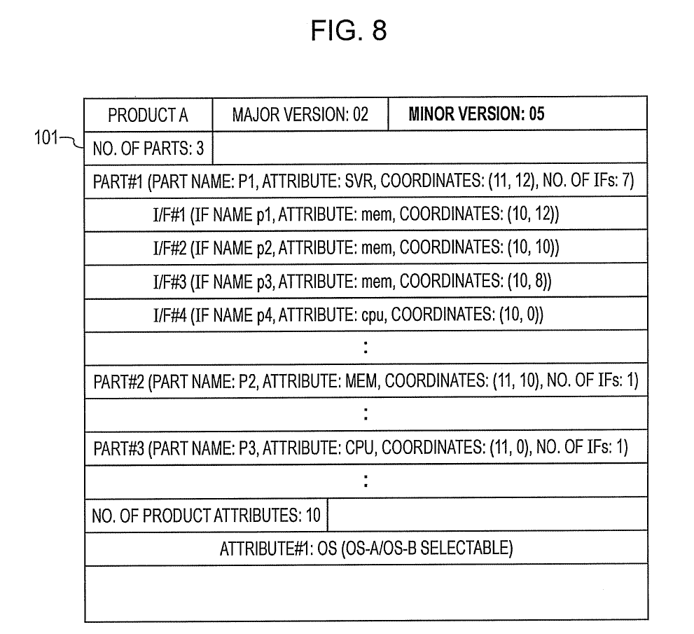

In step S3, the library information reflecting portion 13 replaces the product and/or part with the latest-version product and/or part, and the flow proceeds to step S4. Specifically, the library information reflecting portion 13 makes the latest library information reflect the library information captured in the earlier-version design data 10. For example, the library information reflecting portion 13 updates the earlier-version design data 10 to the latest design data (generates the latest design data) by replacing information included in the earlier-version design data 10 illustrated in FIG. 7 (information of a product library captured in the earlier-version design data 10) with information included in the latest product library 101 illustrated in FIG. 8. It is to be noted that the library information reflecting portion 13 does not replace attribute information of the product A specified by an input from a designer (e.g., setting of “OS-B” as the attribute #1 in FIG. 7) of the information included in the earlier-version design data 10 illustrated in FIG. 7 with corresponding information included in the product library 101 illustrated in FIG. 8.

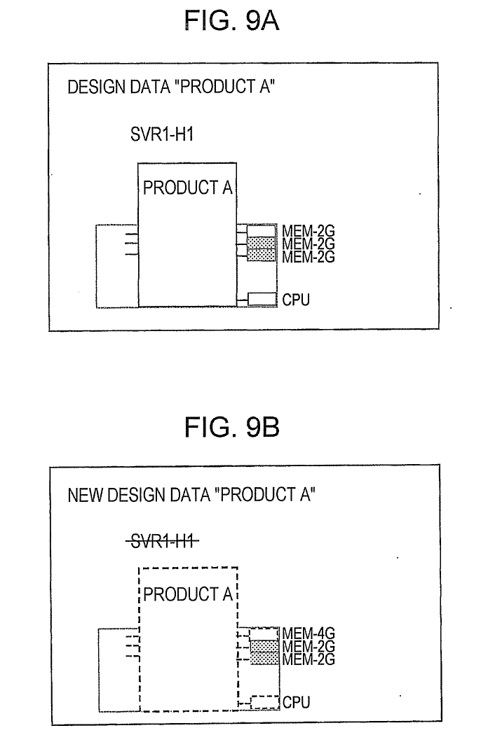

In step S6, the library information reflection impossibility notifying portion 14 provides a notification that the product and/or part cannot be replaced with the latest-version one(s). In step S6, the library information reflection impossibility notifying portion 14 may form a comment of the earlier-version library information of that product and/or part captured in the earlier-version design data 10 (convert the library information into drawing information) and display it on a screen. For example, the library information reflection impossibility notifying portion 14 can form a comment of the product library of the product A captured in the earlier-version design data illustrated in FIG. 9A and display it on a screen as illustrated in FIG. 9B. The portion shown by the dotted lines illustrated in FIG. 9B indicates information of the product library of the product A formed in the comment. The designer who sees the screen display illustrated in FIG. 9B individually calls the latest library information and newly arranges (sets) the latest-version product in the design data. In step S6, the library information reflection impossibility notifying portion 14 may display the reason why the product and/or part cannot be replaced with the latest-version one(s) (reason of impossibility of replacement) on a screen.

In step S4, the attribute information reflection determining portion 15 determines whether the latest design data (the latest design data generated in step S3) can inherit the attribute in the product specified in the earlier-version design data 10. Specifically, the attribute information reflection determining portion 15 determines whether there is a contradiction between the attribute of the product specified in the earlier-version design data 10 and the attribute of the product included in the latest library information. When there is no contradiction therebetween, the attribute information reflection determining portion 15 determines that the latest design data reflecting the latest library information can inherit the attributes of the product specified in the earlier-version design data 10, and the flow proceeds to step S5. When there is a contradiction therebetween, the attribute information reflection determining portion 15 determines that the latest design data reflecting the latest library information cannot inherit the attributes of the product specified in the earlier-version design data 10, and the flow proceeds to step S7.

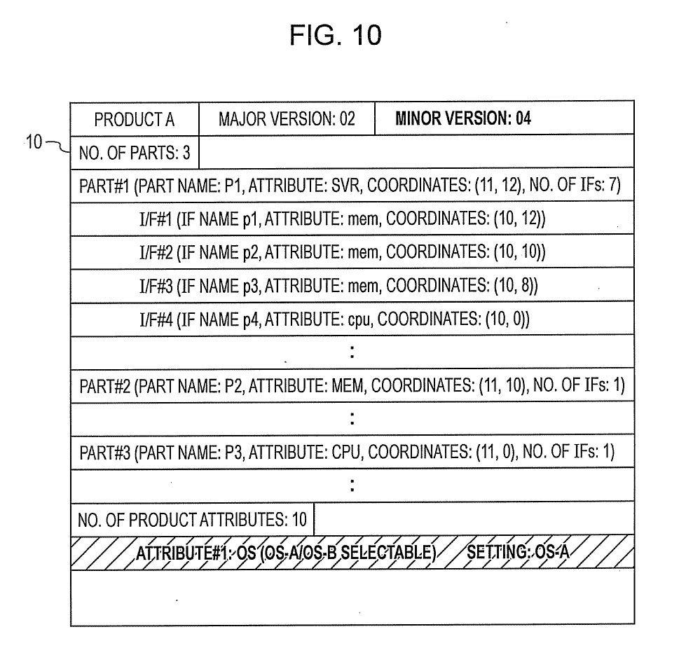

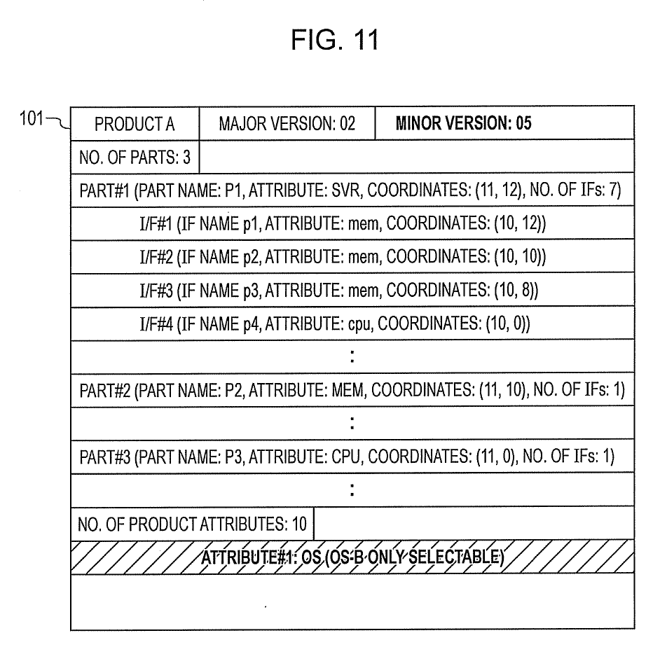

Referring to FIG. 10, in the hatched portion in the earlier-version design data 10, the operating system “OS-A” is set as the attribute (attribute #1) of the product A. In contrast, referring to FIG. 11, in the corresponding attribute of the product A included in the latest product library 101, only the operating system “OS-B” is selectable for the product A. That is, there is a contradiction between the attribute of the product specified in the earlier-version design data 10 illustrated in FIG. 10 and the attribute of the product included in the latest library information illustrated in FIG. 11. Accordingly, the attribute information reflection determining portion 15 determines that the latest design data (not shown) generated by making the latest product library illustrated in FIG. 11 reflect the earlier-version design data 10 cannot inherit the attribute specified in the earlier-version design data 10 illustrated in FIG. 10 (setting: OS-A).

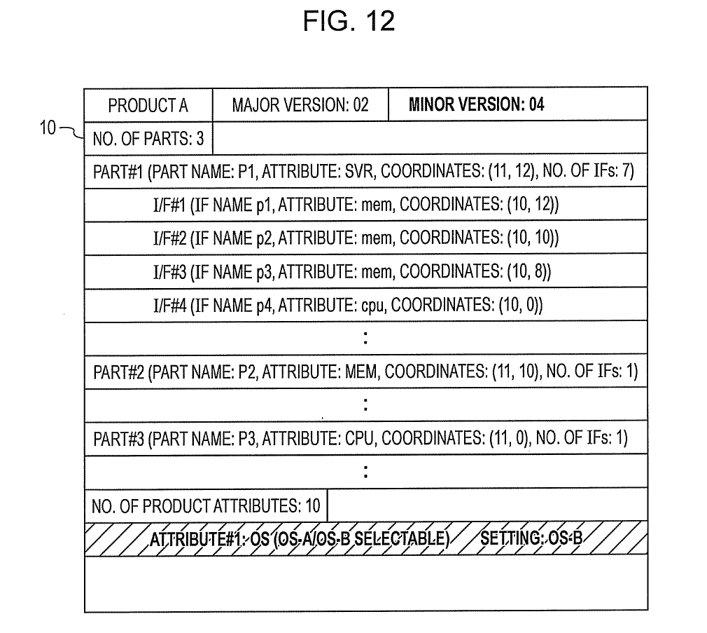

As illustrated in FIG. 12, when the operating system “OS-B” is set as the attribute (attribute #1) of the product A in the earlier-version design data 10, there is no contradiction between that attribute of the product A and the attribute of the product A contained in the latest product library illustrated in FIG. 11. Accordingly, the attribute information reflection determining portion 15 determines that the latest design data (not shown) generated by making the latest product library illustrated in FIG. 11 reflect the earlier-version design data 10 can inherit the attribute specified in the earlier-version design data 10 illustrated in FIG. 12 (setting: OS-B).

In step S5, the attribute information reflecting portion 16 makes the latest design data reflecting the latest library information inherit the attribute of the product specified in the earlier-version design data 10.

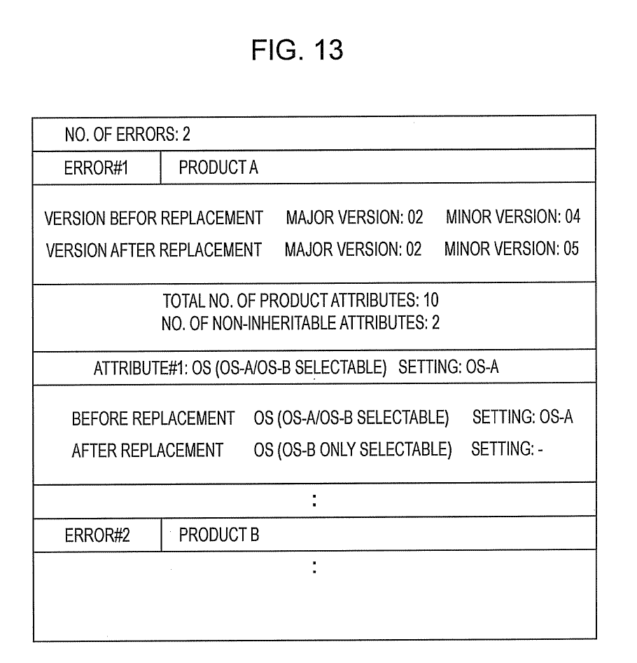

In step S7, the attribute information error notifying portion 17 provides a notification that the latest design data reflecting the latest library information cannot inherit the attribute of the product specified in the earlier-version design data 10 (an error notification). For example, the attribute information error notifying portion 17 can display an error list illustrated in FIG. 13 on a screen. The error list illustrated in FIG. 13 indicates that the attribute #1 is one non-inheritable attribute. For example, the designer who sees the error list can recognize OS-A of the setting for the operating system of the product A as being an error and can correct it in the design data.

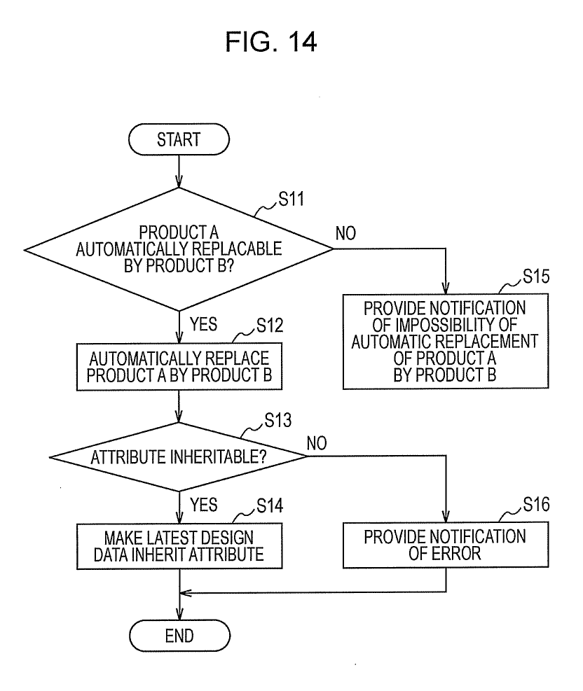

A second embodiment of the present invention is described next. FIG. 14 illustrates an example flowchart of a process in an aiding method for design according to the second embodiment. With reference to FIG. 14, how the system aiding for design 1 carries out the aiding method for design when an instruction to replace the product A indicated by the product library captured in the earlier-version design data with a product different from the product A (e.g., product B) is provided by an input from a designer is described. The instruction to perform the replacement can include, for example, identifying information of the product A and identifying information of the product B.

First, in step S11, the library information reflection determining portion 12 determines whether the product A can be replaced with the product B. Specifically, the library information reflection determining portion 12 acquires a product library of the product A captured in the earlier-version design data 10 (pre-replacement product library) from the design data storage 18 on the basis of the identifying information of the product A contained in the above instruction to perform the replacement. The library information reflection determining portion 12 acquires a product library of the product B (post-replacement product library) from the library information storage 19 on the basis of the identifying information contained in the above instruction to perform the replacement. The library information reflection determining portion 12 determines whether there is a contradiction between a physical condition contained in the product library of the product A captured in the earlier-version design data 10 and a physical condition contained in the product library of the product B. When there is no contradiction therebetween, the library information reflection determining portion 12 determines that the product A can be replaced with the product B, and the flow proceeds to step S12. When there is a contradiction therebetween, the library information reflection determining portion 12 determines that the product A cannot be replaced with the product B, and the flow proceeds to step S15.

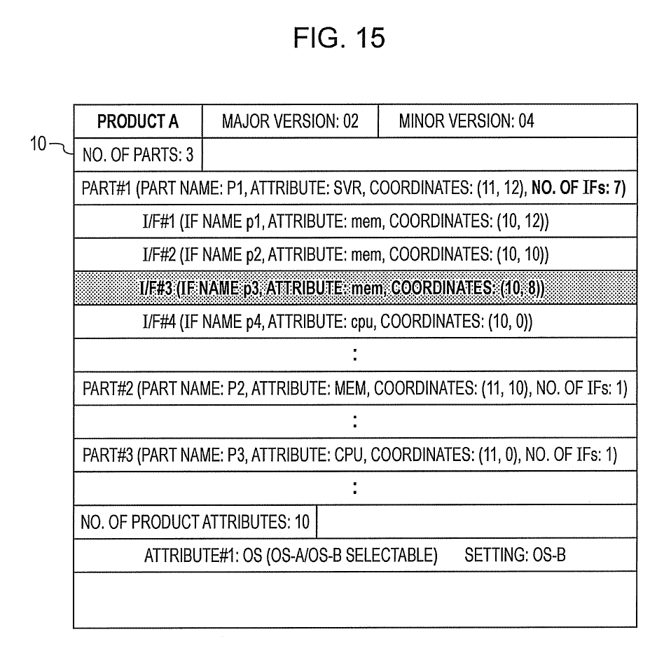

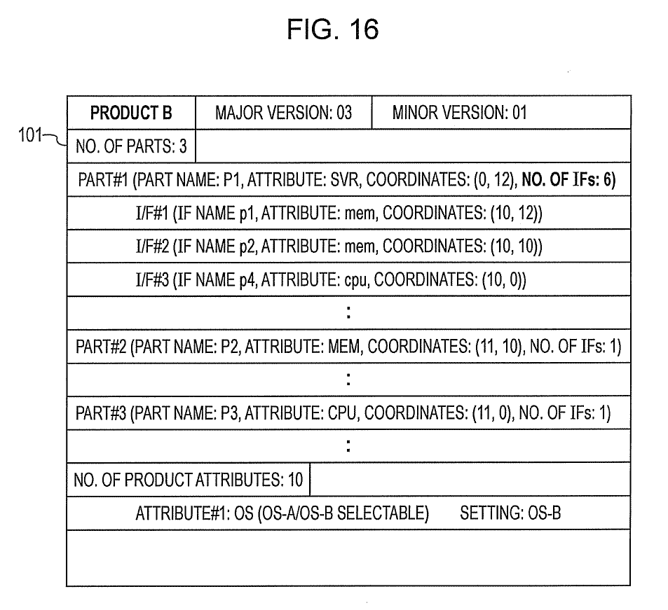

For example, it is assumed that the earlier-version design data capturing the product library of the product A is the design data 10 illustrated in FIG. 15 and the product library of the product B is the product library 101 illustrated in FIG. 16. The information in the design data 10 illustrated in FIG. 15 is information of the product library of the product A captured in the design data 10. The library information reflection determining portion 12 can, for example, determine whether there is a contradiction between the number of interfaces and the attribute and coordinates of each interface in the design data 10 illustrated in FIG. 15 and those in the product library 101 illustrated in FIG. 16. In the examples illustrated in FIGS. 15 and 16, the number of interfaces of the part #1 in the design data 10 illustrated in FIG. 15 is seven, whereas the number of interfaces of the part #1 in the product library 101 illustrated in FIG. 16 is six. In addition, the same attribute and coordinates as the attribute and coordinates of the IF #3 of the part #1 in the design data 10 illustrated in FIG. 15 are not present in the product library 101 illustrated in FIG. 16. That is, information of the hatched portion in FIG. 15 contradicts information included in the product library 101 illustrated in FIG. 16. Therefore, the library information reflection determining portion 12 determines that the product A cannot be replaced with the product B.

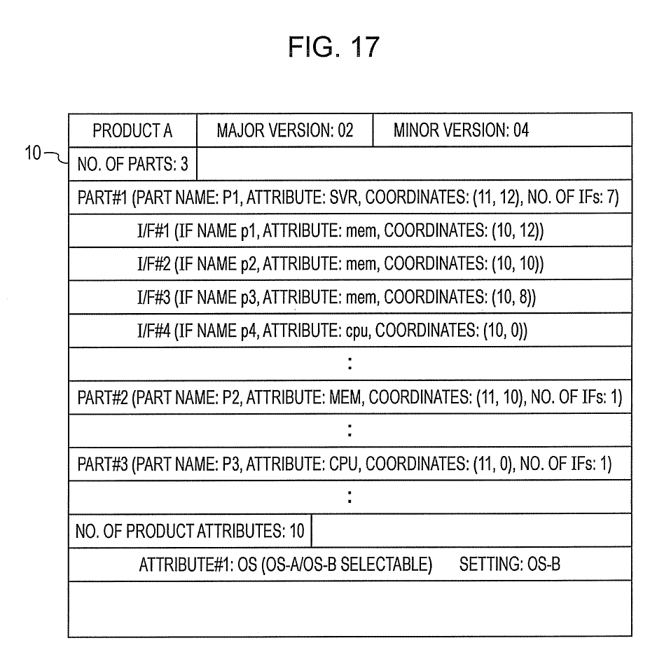

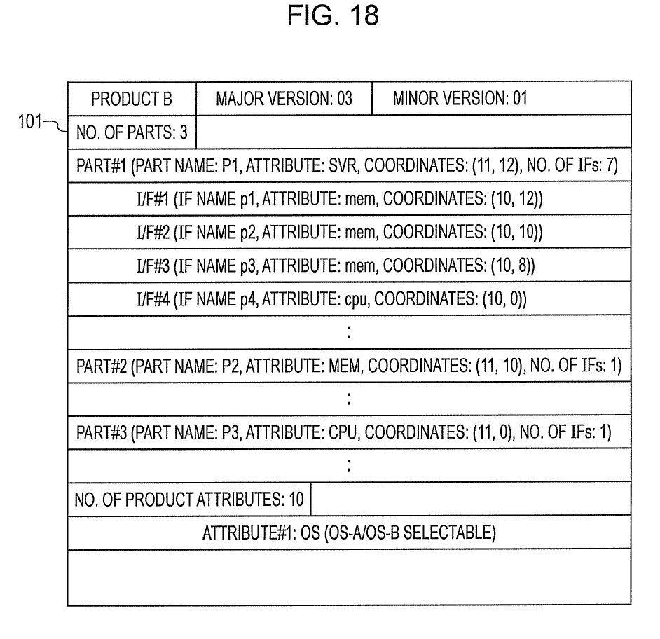

In step S12, the library information reflecting portion 13 replaces the product A with the product B, and the flow proceeds to step S13. Specifically, in step S12, the library information reflecting portion 13 makes the product library of the product B reflect the product library of the product A captured in the design data 10. The library information reflecting portion 13 updates the design data 10 to the latest design data by, for example, replacing the information contained in the design data 10 illustrated in FIG. 17 (information of the product library of the product A) with the information contained in the product library 101 of the product B illustrated in FIG. 18.

In step S15, the library information reflection impossibility notifying portion 14 provides a notification that the product A cannot be replaced with the product B. For example, the library information reflection impossibility notifying portion 14 can display a message indicating the impossibility of replacing the product A with the product B and the reason of the impossibility of the replacement on a screen. When the designer who sees the message displayed on the screen wishes to perform the replacement, the designer individually performs the replacement using a manual operation.

In step S13, the attribute information reflection determining portion 15 determines whether the latest design data reflecting the product library of the product B can inherit the attribute of the product A specified in the earlier-version design data 10 capturing the product library of the product A. Specifically, the attribute information reflection determining portion 15 determines whether there is a contradiction between the attribute of the product A specified in the earlier-version design data 10 and the attribute of the product B contained in the product library of the product B. When there is no contradiction therebetween, the attribute information reflection determining portion 15 determines that the latest design data reflecting the product library of the product B can inherit the attribute of the product A specified in the earlier-version design data 10 capturing the product library of the product A, and the flow proceeds to step S14. When there is a contradiction therebetween, the attribute information reflection determining portion 15 determines that the latest design data reflecting the product library of the product B cannot inherit the attribute of the product A specified in the earlier-version design data 10 capturing the product library of the product A, and the flow proceeds to step S16.

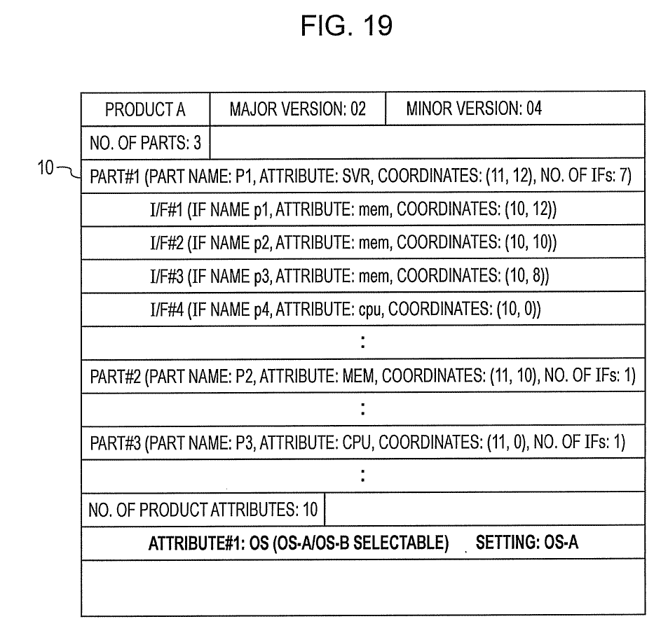

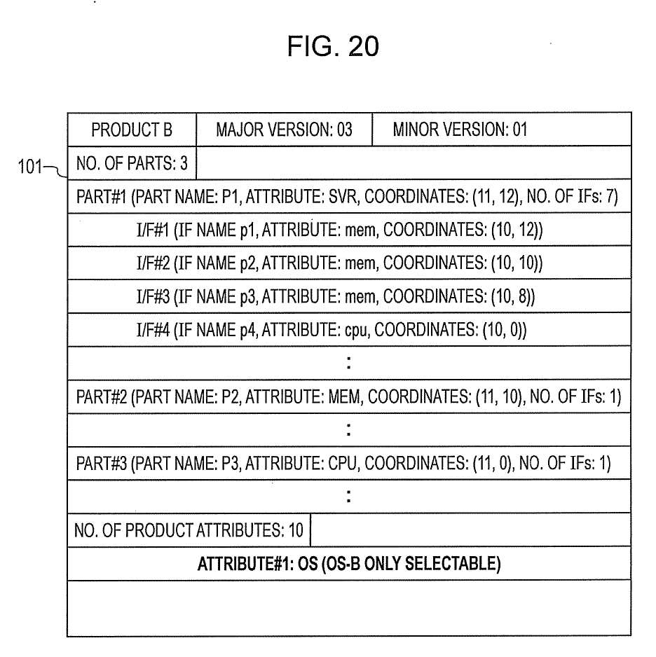

Referring to FIG. 19, in the earlier-version design data 10, the operating system “OS-A” is set as the attribute (attribute #1) of the product A. In contrast, referring to FIG. 20, in the corresponding attribute of the product B included in the latest product library 101, only the operating system “OS-B” is selectable for the product B. That is, there is a contradiction between the attribute of the product A specified in the earlier-version design data 10 illustrated in FIG. 19 and the attribute of the product B indicated by the latest library information 101 illustrated in FIG. 20. Accordingly, the attribute information reflection determining portion 15 determines that the latest design data (not shown) reflecting the product library of the product B illustrated in FIG. 20 cannot inherit the attribute specified in the earlier-version design data 10 illustrated in FIG. 19 (setting: OS-A).

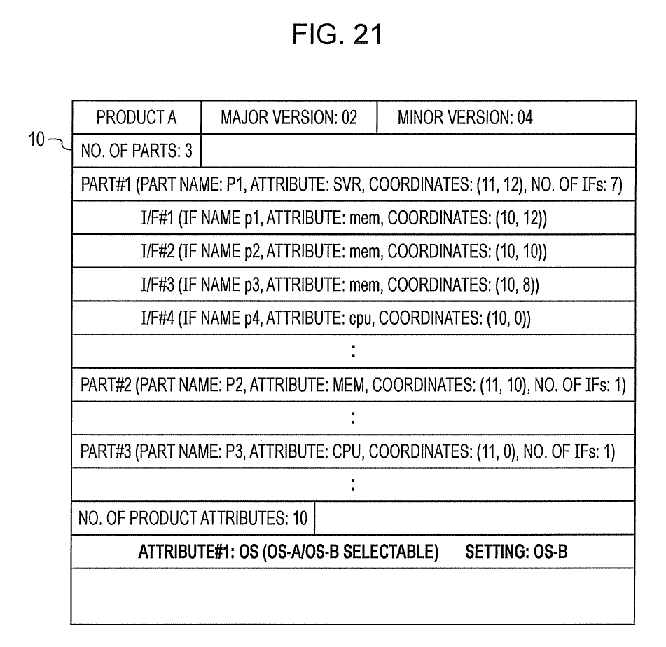

As illustrated in FIG. 21, when the operating system “OS-B” is set as the attribute (attribute #1) of the product A in the earlier-version design data 10, there is no contradiction between that attribute of the product A and the attribute of the product B contained in the latest product library 101 illustrated in FIG. 20. Accordingly, the attribute information reflection determining portion 15 determines that the latest design data (not shown) reflecting the product library of the product B illustrated in FIG. 20 can inherit the attribute of the product A specified in the earlier-version design data illustrated in FIG. 21 (setting: OS-B).

In step S14, the attribute information reflecting portion 16 makes the latest design data reflecting the product library of the product B inherit the attribute of the product A specified in the earlier-version design data 10.

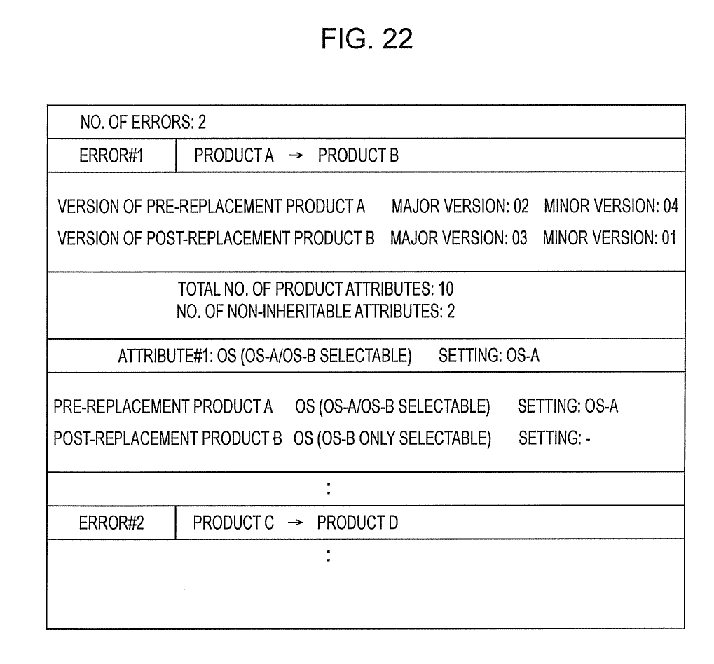

In step S16, the attribute information error notifying portion 17 provides a notification that the latest design data reflecting the product library of the product B cannot reflect the attribute of the product A specified in the earlier-version design data 10 (an error notification). For example, the attribute information error notifying portion 17 can display an error list illustrated in FIG. 22 on a screen. For example, the designer who sees the error list can recognize OS-A of the setting for the operating system of the product A as being an error if the product A is a pre-replacement product that is replaced with the product B, being a post-replacement product, and can correct it in the design data.

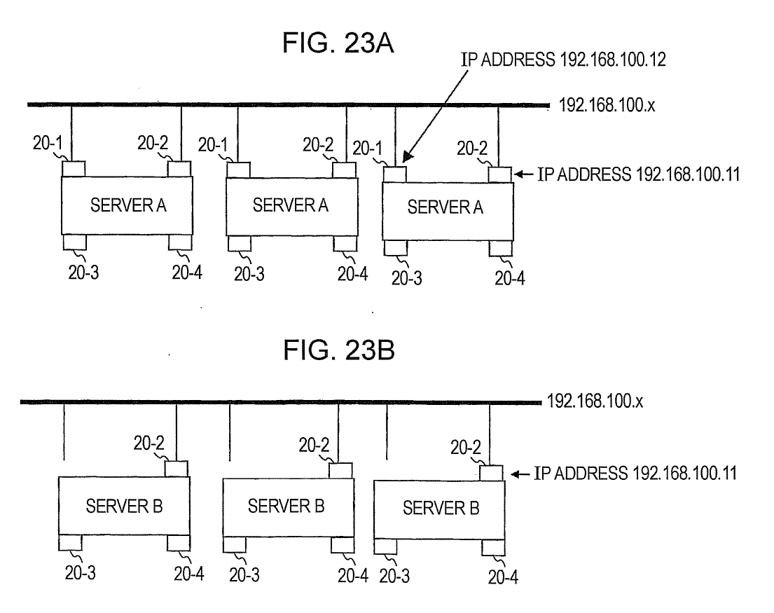

The system aiding for design I according to the present embodiment can be used in replacing a first device included in a network system (e.g., server) with a second device upgraded from the first device. FIG. 23A illustrates an example configuration of a network system including a plurality of servers A. FIG. 23B illustrates an example configuration of a network system in which the servers A illustrated in FIG. 23A are replaced with servers B upgraded from the servers A. Referring to FIGS. 23A and 23B, each of the servers A has four slots 20-1 to 20-4 for local area network (LAN) (LAN connectors), whereas each of the servers B has only three LAN connectors. Accordingly, to design the network system illustrated in FIG. 23B, it is necessary to purchase one LAN card and add it and also to set an internet protocol (IP) address set in the server A in the added LAN card.

The system aiding for design 1 according to the present embodiment displays an IP address that cannot be set in the server B (e.g., the IP address 192.168.100.12, which is set in the LAN connector 20-1 included in the server A) because the number of LAN slots is reduced among the IP addresses set in the server A illustrated in FIG. 23A as an error list in accordance with the flowchart for the aiding method for design described above with reference to FIG. 14. The designer can recognize that the number of LAN slots is reduced in the server B and that there is an IP address that becomes unable to be set because of the reduction by referring to the error list.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A system aiding for design, comprising:
a determining unit determining whether it is possible to first product data with second product data by comparing interface data of the first product data with interface data of the second product data; and
a replacing unit replacing the first product data contained in design data with the second product data when the determining unit determines that replacement is possible.

2. The system aiding for design according to claim 1, wherein the interface data indicates at least one add-on device, and the determining unit determines whether replacement is possible in accordance with a possibility of connecting the at least one add-on device connected to a product indicated by the first product data to a product indicated by the second product data.

3. The system aiding for design according to claim 2, wherein the at least one add-on device comprises a plurality of add-on devices, and the determining unit determines whether replacement is possible in accordance with a possibility of connecting all of the plurality of add-on devices connected to the product indicated by the first product data to the product indicated by the second product data.

4. The system aiding for design according to claim 1, wherein the interface data indicates at least one communication cable, and the determining unit determines whether replacement is possible in accordance with a possibility of connecting the at least one communication cable connected to a product indicated by the first product data to a product indicated by the second product data.

5. The system aiding for design according to claim 4, wherein the at least one communication cables comprises a plurality of communication cables, and the determining unit determines whether replacement is possible in accordance with a possibility of connecting all of the plurality of communication cables connected to the product indicated by the first product data to the product indicated by the second product data.

6. The system aiding for design according to claim 1, wherein the interface data indicates software, and the determining unit determines whether replacement is possible in accordance with a possibility of selecting the software used in a product indicated by the first product data in a product indicated by the second product data.

7. The system aiding for design according to claim 1, further comprising:
a notifying unit providing a notification of a reason why the replacing is not possible when the determining unit determines that replacement is not possible.

8. An aiding method for design, comprising:
determining whether it is possible to replace first product data with second product data by comparing interface data of the first product data with interface data of the second product data; and
replacing the first product data contained in design data with the second product data when the determining unit determines that replacement is possible.

9. A computer-readable recording medium encoded with a computer program that causes a computer to operate as a system aiding for design, the program when executed by a computer causes the computer to perform a method comprising:
determining whether it is possible to replace first product data with second product data by comparing interface data of the first product data with interface data of the second product data; and
replacing the first product data contained in design data with the second product data when the determining unit determines that replacement is possible.
